(19) United States
(12) Patent Application Publication
(10) Pub. No.: US 2025/0147837 A1
(43) Pub. Date: May 8, 2025

(54) PRIORITY DETERMINATION SYSTEM AND PRIORITY DETERMINATION METHOD

(71) Applicant: Panasonic Automotive Systems Co., Ltd., Kanagawa (JP)

(72) Inventors: Katsuyuki ITOU, Kanagawa (JP); Masayoshi OHTANI, Kanagawa (JP); Yuki FUKUHARA, Kanagawa (JP); Hirotaka FUKUI, Kanagawa (JP); Takuma IIDA, Kanagawa (JP)

(73) Assignee: Panasonic Automotive Systems Co., Ltd., Kanagawa (JP)

(21) Appl. No.: 19/015,167

(22) Filed: Jan. 9, 2025

Related U.S. Application Data
(63) Continuation of application No. PCT/JP2023/022939, filed on Jun. 21, 2023.

(30) Foreign Application Priority Data
Oct. 27, 2022 (JP) 2022-172040

(51) Int. Cl. G06F 11/07; H04L 9/40

(52) U.S. Cl. CPC G06F 11/079; G06F 11/0709; H04L 63/1433

(57) ABSTRACT

A priority determination system includes: an anomaly obtainer that obtains a plurality of items of anomaly data; a circumstance obtainer that obtains a plurality of items of circumstance data; a risk value calculator that calculates a risk value; a priority determiner that determines the priority of each task based on the risk value; an outputter that provides an output based on the result of the determination; and a circumstance change notification manager that determines whether or not each of the plurality of items of anomaly data is circumstance change notification target data. The circumstance change notification manager requests a mobile object corresponding to anomaly data determined to be the circumstance change notification target data to send circumstance data after change. The risk value calculator recalculates the risk value based on the circumstance data after change. The priority determiner redetermines the priority of a task based on the recalculated risk value.

### CROSS REFERENCE TO RELATED APPLICATIONS

This is a continuation application of PCT International Application No. PCT/JP2023/022939 filed on Jun. 21, 2023, designating the United States of America, which is based on and claims priority of Japanese Patent Application No. 2022-172040 filed on Oct. 27, 2022. The entire disclosures of the above-identified applications, including the specifications, drawings and claims are incorporated herein by reference in their entirety.

### FIELD

The present disclosure relates to a priority determination system and a priority determination method.

### BACKGROUND ART

A priority determination system has been disclosed which calculates the risk value of an anomaly of a mobile object based on not only details of the anomaly but also circumstances of the mobile object and determines the priorities of tasks to address the anomaly based on the risk value (for example, Patent Literature (PTL) 1). For example, even if the same attack is made on a plurality of mobile objects, the risk value varies with the circumferences of the attacked mobile objects, and thus, the priorities of tasks determined based on the risk value also vary. Therefore, which task should be executed for an anomaly of which mobile object can be more easily determined.

### CITATION LIST

### Patent Literature

PTL 1: Japanese Unexamined Patent Application Publication No. 2021-149260

### SUMMARY

### Technical Problem

However, the system disclosed in PTL 1 can be improved upon.

In view of this, the present disclosure provides a priority determination system capable of improving upon the above related art.

### Solution to Problem

A priority determination system according to one aspect of the present disclosure includes: an anomaly obtainer that obtains a plurality of items of anomaly data each of which indicates an anomaly of a corresponding one of a plurality of mobile objects; a circumstance obtainer that obtains a plurality of items of circumstance data each of which indicates circumstances of a corresponding one of the plurality of mobile objects; a risk value calculator that calculates, for each of the plurality of items of anomaly data, a risk value that indicates a risk of an anomaly based on circumstance data about a corresponding mobile object; a priority determiner that determines a priority of each task to address an anomaly indicated by each of the plurality of items of anomaly data, based on the risk value of the anomaly data; an outputter that provides an output based on a result of the determination; and a circumstance change notification manager that determines whether or not each of the plurality of items of anomaly data is circumstance change notification target data that requests a corresponding mobile object to send circumstance data after change when circumstances have changed. The circumstance change notification manager requests a mobile object corresponding to anomaly data determined to be the circumstance change notification target data to send circumstance data after change when circumstances have changed. When circumstance data after change is obtained, the risk value calculator recalculates the risk value of the anomaly data about the corresponding mobile object based on the circumstance data after change. The priority determiner redetermines the priority of a task to address an anomaly indicated by the anomaly data about the corresponding mobile object based on the recalculated risk value.

A priority determination method according to one aspect of the present disclosure includes: obtaining a plurality of items of anomaly data each of which indicates an anomaly of a corresponding one of a plurality of mobile objects; obtaining a plurality of items of circumstance data each of which indicates circumstances of a corresponding one of the plurality of mobile objects; calculating, for each of the plurality of items of anomaly data, a risk value that indicates a risk of an anomaly based on circumstance data about a corresponding mobile object; determining a priority of each task to address an anomaly indicated by each of the plurality of items of anomaly data, based on the risk value of the anomaly data; providing an output based on a result of the determination; and determining whether or not each of the plurality of items of anomaly data is circumstance change notification target data that requests a corresponding mobile object to send circumstance data after change when circumstances have changed; requesting a mobile object corresponding to anomaly data determined to be the circumstance change notification target data to send circumstance data after change when circumstances have changed; when circumstance data after change is obtained, recalculating the risk value of the anomaly data about the corresponding mobile object based on the circumstance data after change; and redetermining the priority of a task to address an anomaly indicated by the anomaly data about the corresponding mobile object based on the recalculated risk value.

### Advantageous Effects

The priority determination system and the like according to an aspect of the present disclosure is capable of improving upon the above related art.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a configuration diagram illustrating an example of a priority determination system according to an embodiment.

FIG. 2 is a diagram illustrating an example of an incident management table on a mobile object basis.

FIG. 3 is a sequence diagram illustrating an example of a flow of operations of the priority determination system and mobile objects according to the embodiment.

FIG. 4 is a flowchart illustrating an example of an operation of the priority determination system according to the embodiment.

FIG. 5 is a diagram illustrating an example of anomaly data and circumstance data.

FIG. 6 is a diagram illustrating an example of model information.

FIG. 7 is a diagram illustrating an example of scale factors for various types of circumstance data for correcting a base risk value.

FIG. 8 is a diagram illustrating an example of circumstance change notification target data.

FIG. 9 is a flowchart illustrating an example of an operation concerning circumstance change notification by the mobile object according to the embodiment.

FIG. 10 is a diagram for describing a method of determining a circumstance change for various circumstance items.

FIG. 11 is a flowchart illustrating an example of an operation of the priority determination system in a circumstance change notification waiting state according to the embodiment.

### DESCRIPTION OF EMBODIMENTS

The priority determination system disclosed in PTL 1 described above is not designed to reassess the risk value when circumstances of the mobile object change after circumstance data about the mobile object is once obtained. For example, it is assumed that the traveling state of the mobile object was “being stopped” at the time of occurrence of an anomaly, so that a low risk value was calculated, the priority of a task to address the anomaly was determined to be low, and thus assignment of the task to the analyst was pending. And it is assumed that after that, the traveling state of the mobile object changed to “traveling”. In this case, although the risk of the anomaly increases, the priority of the task remains low, assignment of the task to the analyst is kept in the pending state, and thus, there is a possibility that it is late to address the anomaly whose risk has increased. Hereinafter, a priority determination system and the like that can appropriately determine the priorities of tasks according to a change in circumstances of a mobile object will be described.

### Embodiment

In the following, a priority determination system according to an embodiment will be described with reference to the drawings.

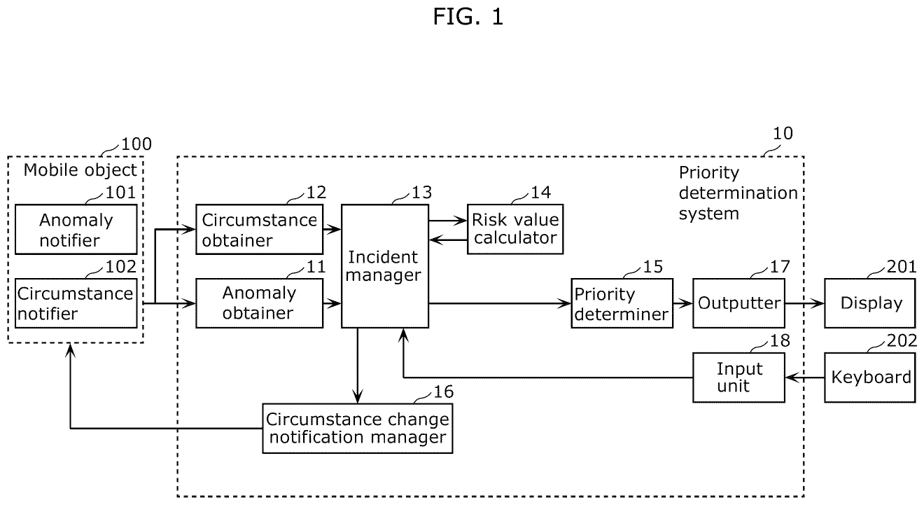

FIG. 1 is a configuration diagram illustrating an example of priority determination system 10 according to an embodiment. Note that FIG. 1 also illustrates mobile object 100 (an automobile, for example) communicatively connected to priority determination system 10, and display 201 and keyboard 202 used by an analyst or the like who addresses an anomaly. Note that there are a plurality of mobile objects 100 communicatively connected to priority determination system 10, although FIG. 1 illustrates only one mobile object 100.

Each of the plurality of mobile objects 100 communicatively connected to priority determination system 10 is a vehicle, such as an automobile provided with an on-board network, such as the controller area network (CAN), and is a connected car capable of radio communication with priority determination system 10 and the like.

Mobile object 100 includes anomaly notifier 101 and circumstance notifier 102. When an anomaly, such as an external attack or unauthorized access or a failure, occurs in the on-board network or an electronic control unit (ECU) or the like connected to the on-board network, anomaly notifier 101 transmits anomaly data indicating the anomaly to priority determination system 10. Note that anomaly notifier 101 may transmit log data of the on-board network to an anomaly detection server or the like that performs anomaly detection, and the anomaly detection server or the like may transmit anomaly data indicating the detected anomaly to priority determination system 10 based on the log data. In addition, circumstance notifier 102 transmits circumstance data indicating the circumstance of itself (mobile object 100 provided with circumstance notifier 102) to priority determination system 10. For example, circumstance notifier 102 may transmit circumstance data to priority determination system 10 constantly or at every specific time intervals. As described in detail later, circumstance notifier 102 has a function of transmitting circumstance data after change to priority determination system 10 when the circumstance of circumstance notifier 102 has changed.

An analyst monitors mobile object 100 using a terminal, such as a security operation center (SOC), for example. For example, the terminal is a terminal that collects anomaly information from a plurality of mobile objects 100 (such as 100 or 1000 mobile objects), analyzes details of any anomaly detected, and makes a notification to a security incident response team (SIRT) or the like. For example, the terminal can use software, such as security information and event management (SIEM). Priority determination system 10 is designed to serve as a server system in cooperation with SIEM or security orchestration automation and response (SOAR). As described later, priority determination system 10 can provide, to the terminal, an output based on the determination of the priority of a task to address an anomaly, and according to the output, the analyst can effectively execute a task among many tasks to address abnormalities that occur in many mobile objects 100. The terminal is capable of wire or radio communication with priority determination system 10. For example, display 201 and keyboard 202 are connected to the terminal.

Priority determination system 10 is a computer, such as a server, for determining the priority of a task to be executed by the analyst. Priority determination system 10 includes a processor, a memory, a communication interface, and the like. The memory is a read only memory (ROM), a random access memory (RAM), and the like, and can store a program to be executed by the processor. Priority determination system 10 includes anomaly obtainer 11, circumstance obtainer 12, incident manager 13, risk value calculator 14, priority determiner 15, circumstance change notification manager 16, outputter 17, and input unit 18. Anomaly obtainer 11, circumstance obtainer 12, incident manager 13, risk value calculator 14, priority determiner 15, circumstance change notification manager 16, outputter 17, and input unit 18 are implemented by the processor or the like executing a program stored in the memory. The components forming priority determination system 10 may be distributed among a plurality of servers.

Anomaly obtainer 11 obtains a plurality of items of anomaly data. Each of the plurality of items of anomaly data indicates an anomaly of a corresponding one of the plurality of mobile objects 100. For example, anomaly obtainer 11 obtains a plurality of items of anomaly data from the plurality of mobile objects 100 (or anomaly detection servers or the like) via the communication interface of priority determination system 10.

Circumstance obtainer 12 obtains a plurality of items of circumstance data. Each of the plurality of items of circumstance data indicates a circumstance of a corresponding one of the plurality of mobile objects 100. For example, circumstance obtainer 12 obtains a plurality of items of circumstance data from the plurality of mobile objects 100, roadside devices, servers, or the like via the communication interface of priority determination system 10. For example, each of the plurality of items of circumstance data includes at least one item of information among type information indicating the type (model, for example) of mobile object 100, position information indicating the position of mobile object 100, traffic information about a site corresponding to the position information, traveling state information indicating the traveling state of mobile object 100, driving assistance state information indicating the driving assistance state of mobile object 100, and charge/discharge state information indicating the charge/discharge state of mobile object 100. For example, circumstance obtainer 12 may obtain position information, traveling state information, driving assistance state information, and charge/discharge state information from mobile object 100, obtain, from the server, type information or information about an anomaly occurrence situation (such as a popular attack) or the like managed by the server, and obtain traffic information about the site where an anomaly of mobile object 100 has occurred from a roadside device. Note that each of the plurality of items of circumstance data may be a combination of these items of information and additional information from another server or the like.

Incident manager 13 manages the plurality of items of anomaly data obtained by anomaly obtainer 11 and the plurality of items of circumstance data obtained by circumstance obtainer 12. For example, incident manager 13 manages the anomaly data and the circumstance data on a mobile object 100 basis. In addition, for example, incident manager 13 manages a risk value calculated by risk value calculator 14 described later in association with corresponding anomaly data.

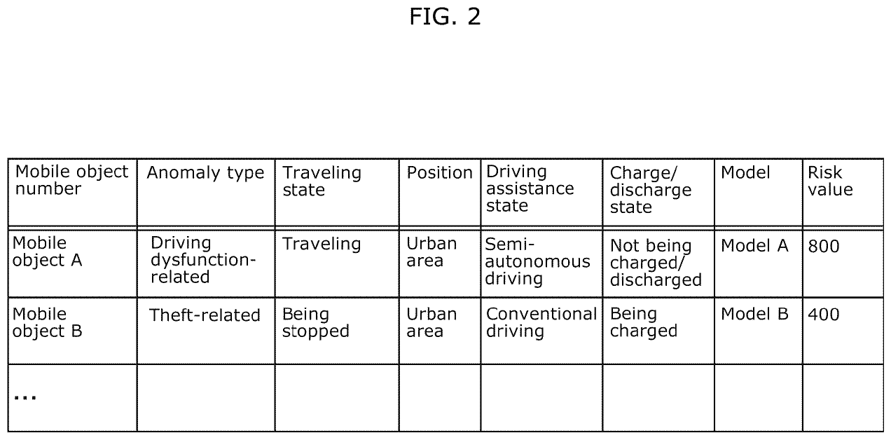

FIG. 2 is a diagram illustrating an example of an incident management table on a mobile object 100 basis.

For example, in the incident management table, as illustrated in FIG. 2, incident manager 13 manages anomaly type, traveling state, position, driving assistance state, charge/discharge state, model, and risk value on a mobile object 100 basis. For example, incident manager 13 manages facts about mobile object A that a driving dysfunction-related anomaly has occurred, mobile object A is traveling, mobile object A is located in an urban area, mobile object A is in the semi-autonomous driving state, mobile object A is not being charged or discharged, mobile object A is model A, and the risk value of the driving dysfunction-related anomaly in the current situation of mobile object A is 800. In addition, incident manager 13 manages facts about mobile object B that a theft-related anomaly has occurred, mobile object B is stopped, mobile object B is located in an urban area, mobile object B is in the conventional driving state, mobile object B is being charged, mobile object B is model B, and the risk value of the theft-related anomaly in the current situation of mobile object B is 400.

Risk value calculator 14 calculates a risk value that indicates an anomaly risk for each of the plurality of items of anomaly data based on the circumstance data about corresponding mobile object 100. For example, risk value calculator 14 calculates a risk value based on anomaly data (such as anomaly type) and circumstance data (such as traveling state, position, driving assistance state, charge/discharge state, and model) in the incident management table illustrated in FIG. 2 managed by incident manager 13. For example, risk value calculator 14 calculates a risk value each time anomaly data or circumstance data is obtained. Risk value calculator 14 will be described in detail later.

Priority determiner 15 determines the priority of each task to address the anomaly indicated by each of the plurality of items of anomaly data based on the risk value of the anomaly data. For example, priority determiner 15 determines the priority of each task based on the risk value of each of the plurality of items of anomaly data and a predetermined index value of the task, such as at least one of the percentage of decrease of the risk by execution of the task and the time required to execute the task. For example, priority determiner 15 determines the priority of each task based on the risk value of each of the plurality of items of anomaly data and, as predetermined index values of the task, the percentage of decrease of the risk by execution of the task and the time required to execute the task. Priority determiner 15 will be described in detail later. Note that the predetermined index value of each task may also be a value indicating the load of the task or a value indicating the degree of influence of the task on the risk, for example. For example, priority determiner 15 performs the determination described above regularly, each time a task is executed, each time an anomaly is detected, or each time a risk value is calculated.

Note that, although not illustrated, priority determination system 10 may store a rule used when risk value calculator 14 calculates a risk value and a rule used when priority determiner 15 determines priorities. These rules will be described in detail later.

Although not illustrated, priority determination system 10 may store an association between the anomaly indicated by each of the plurality of items of anomaly data and one or more tasks to address the anomaly. Furthermore, priority determination system 10 may store, for each task, the percentage of decrease of the risk by execution of the task (referred to also as a share ratio of the risk value) and the estimated response time required to complete the task. These will be described in detail later.

Circumstance change notification manager 16 determines, for each of the plurality of items of anomaly data, whether or not the anomaly data is circumstance change notification target data that requires corresponding mobile object 100 to send circumstance data after change when circumstances have changed. Circumstance change notification manager 16 will be described in detail later. Outputter 17 provides an output based on the result of the determination of priorities by priority determiner 15 to the terminal such as SOC (such as display 201). Outputter 17 transmits the result of the determination of priorities to the terminal such as SOC via the communication interface or the like of priority determination system 10. The output of outputter 17 will be described in detail later.

To input unit 18, a fact that an anomaly has been addressed (in other words, a task to address an anomaly has been executed) is input via the terminal such as SOC (such as keyboard 202). Input unit 18 obtains a fact that an anomaly has been addressed via the communication interface or the like of priority determination system 10.

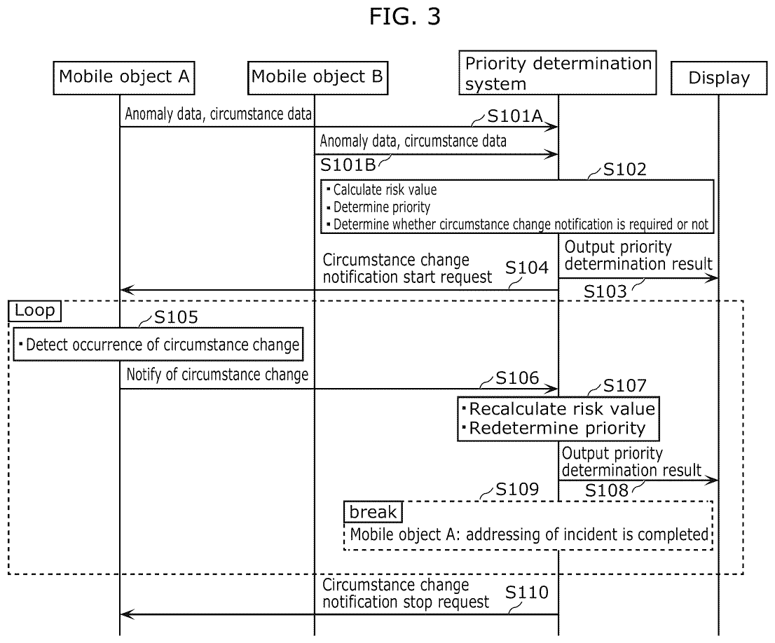

Next, a flow of operations of priority determination system 10 and mobile object 100 will be described with reference to FIG. 3.

FIG. 3 is a sequence diagram illustrating an example of the flow of operations of priority determination system 10 and mobile objects 100 according to the embodiment. In this drawing, mobile objects A and B are illustrated as mobile objects 100.

First, a plurality of mobile objects 100 including mobile objects A and B each transmit anomaly data and circumstance data to priority determination system 10 (step S101A and step S101B). Thus, priority determination system 10 obtains a plurality of items of anomaly data and a plurality of items of circumstance data.

Using the plurality of items of anomaly data and the plurality of items of circumstance data obtained, priority determination system 10 then performs calculation of a risk value, determination of priorities, and determination of whether circumstance change notification is required or not (step S102).

Priority determination system 10 then outputs the result of the determination of priorities to display 201 (step S103). This enables the analyst to execute tasks in order of priority.

Priority determination system 10 then transmits a request to start circumstance change notification (referred to also as a circumstance change notification start request) to mobile object 100 that requires circumstance change notification (mobile object A, for example) (step S104). In response to this, mobile object A transitions to a state where mobile object A monitors for a circumstance change (referred to also as circumstance change monitoring state).

When an occurrence of a circumstance change is detected (step S105), mobile object A notifies priority determination system 10 of the circumstance change (step S106).

Using the notified circumstance data after change, priority determination system 10 then recalculates the risk value and redetermines priorities (step S107).

Priority determination system 10 then outputs the result of the redetermination of priorities to display 201 (step S108). For example, when the priority of a task that was low at the time of step S103 has risen, the analyst can preferentially execute the task.

When addressing of an incident (anomaly) of mobile object A is completed (step S109), for example, when a fact that addressing of an incident of mobile object A is completed is input to input unit 18, priority determination system 10 transmits a request to stop the circumstance change notification (referred to also as circumstance change notification stop request) to mobile object A (step S110). In response to this, mobile object A clears the circumstance change monitoring state.

Note that if another circumstance change occurs in mobile object A before addressing of the incident of mobile object A is completed in step S109, the procedure from step S105 is performed again.

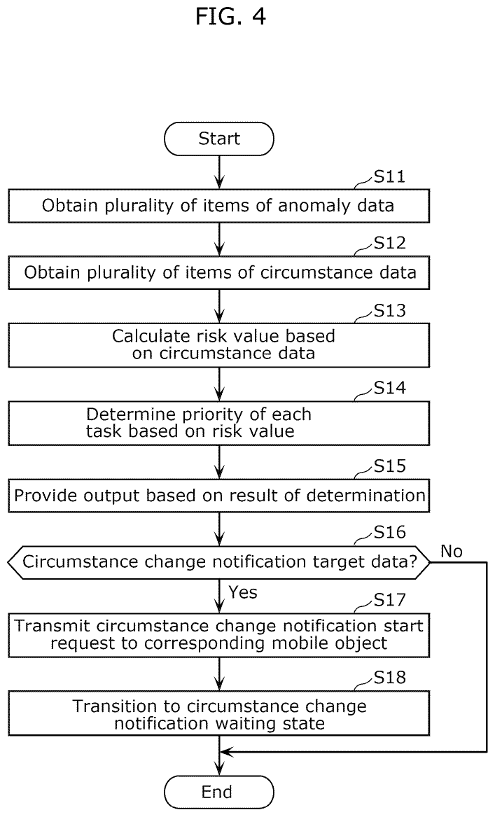

Next, an operation of priority determination system 10 will be described with reference to FIG. 4.

FIG. 4 is a flowchart illustrating an example of an operation of priority determination system 10 according to the embodiment.

First, anomaly obtainer 11 obtains a plurality of items of anomaly data (step S11). Each of the plurality of items of anomaly data indicates an anomaly of a corresponding one of the plurality of mobile objects 100. For example, there are many mobile objects 100 monitored by the terminal such as SOC, and accordingly, anomaly obtainer 11 obtains many items of anomaly data.

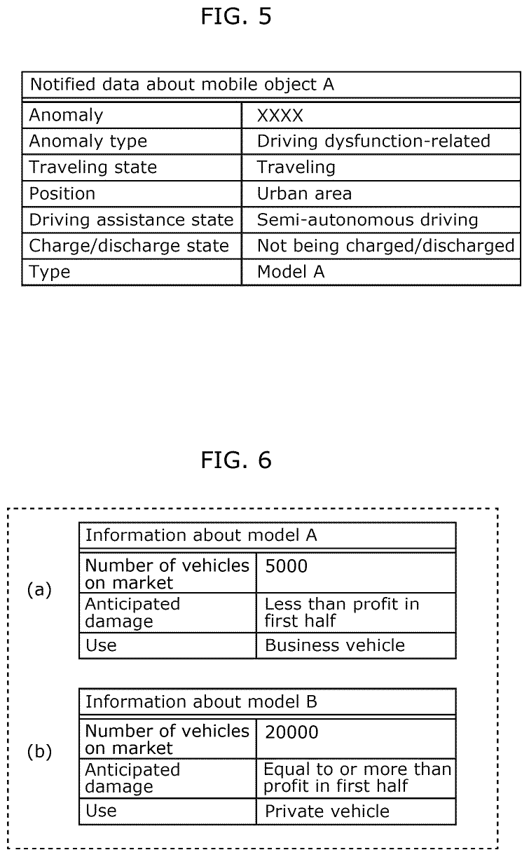

Circumstance obtainer 12 then obtains a plurality of items of circumstance data (step S12). Each of the plurality of items of circumstance data indicates a circumstance of a corresponding one of the plurality of items of mobile objects 100. For example, there are many mobile objects 100 monitored by the terminal such as SOC, and accordingly, circumstance obtainer 12 obtains many items of circumstance data. A specific example of anomaly data and circumstance data will be described with reference to FIG. 5.

FIG. 5 is a diagram illustrating an example of anomaly data and circumstance data. FIG. 5 illustrates an example of anomaly data and circumstance data obtained from mobile object A among a plurality of mobile objects 100.

For example, as illustrated in FIG. 5, the anomaly data obtained from mobile object A includes information “XXXX” that indicates an anomaly of a “driving dysfunction-related” type. On the other hand, the circumstance data obtained from mobile object A includes information indicating that, when the anomaly occurs, the traveling state of mobile object A is “traveling”, the position of mobile object A is “urban area”, the driving assistance state is “semi-autonomous driving”, the charge/discharge state is “not being charged/discharged”, and the type (model) is “model A”.

FIG. 6 is a diagram illustrating an example of model information. Part (a) of FIG. 6 is a diagram illustrating an example information about model A, and Part (b) of FIG. 6 is a diagram illustrating an example of information about model B.

Part (a) of FIG. 6 illustrates that the number of vehicles of model A on the market is 5000, an anticipated damage when a problem occurs is less than the profit in the first half, and vehicles of model A are used as business vehicles. Part (b) of FIG. 6 illustrates that the number of vehicles of model B on the market is 20000, an anticipated damage when a problem occurs is equal to or more than the profit in the first half, and vehicles of model B are used as private vehicles.

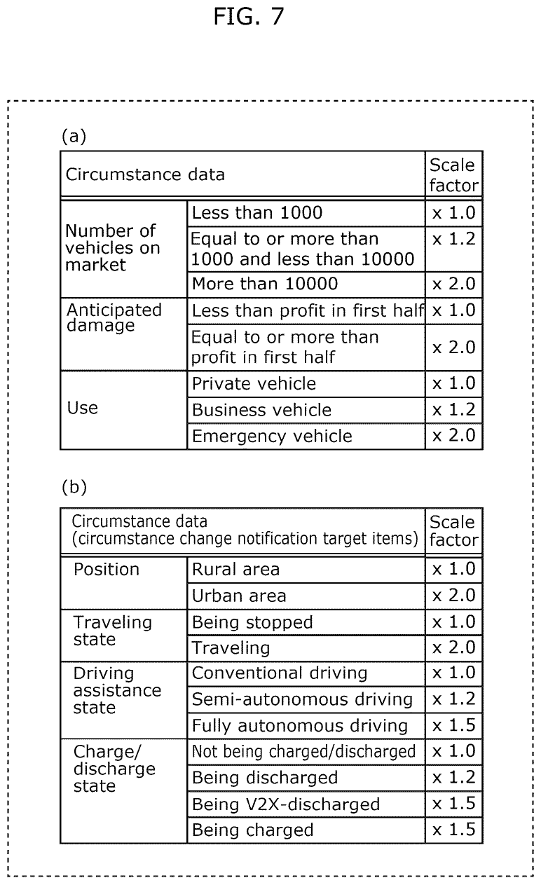

Risk value calculator 14 then calculates, for each of the plurality of items of anomaly data, the risk value of the anomaly based on the circumstance data about corresponding mobile object 100 (step S13). For example, risk value calculator 14 first determines a base risk value for each of the plurality of items of anomaly data. The base risk value is a value calculated according to the type of the anomaly, and can be determined (calculated, for example) using a score value according to SIEM or a score value according to cyber threat intelligence (CTI). The risk value calculated by risk value calculator 14 is the base risk value determined according to the type of the anomaly corrected with the circumstance data about corresponding mobile object 100. The greater the risk value obtained by correcting the base risk value, the higher the risk of the anomaly is. Scale factors for correcting the base risk value will be described hereinafter with reference to FIG. 7.

FIG. 7 is a diagram illustrating an example of scale factors for various types of circumstance data for correcting the base risk value. Note that Part (b) of FIG. 7 illustrates scale factors for circumstance data indicating circumstances that are circumstance change notification target items. The circumstance change notification target item will be described later.

For example, as illustrated in Part (a) of FIG. 7, priority determination system 10 stores a rule that the base risk value of an anomaly that occurs in mobile object 100 of a model described as “the number of vehicles on the market is less than 1000” is corrected by a factor of 1.0, a rule that the base risk value of an anomaly that occurs in mobile object 100 of a model described as “the number of vehicles on the market is equal to or more than 1000 and less than 10000” is corrected by a factor of 1.2, and a rule that the base risk value of an anomaly that occurs in mobile object 100 of a model described as “the number of vehicles on the market is equal to or more than 10000” is corrected by a factor of 2.0. Mobile object 100 of a model described as “the number of vehicles on the market is less than 1000” is small in number of vehicles on the market and therefore has a small influence if an anomaly occurs, so that the base risk value of an anomaly that occurs in mobile object 100 of a model described as “the number of vehicles on the market is less than 1000” is not substantially corrected. On the other hand, mobile object 100 of a model described as “the number of vehicles on the market is equal to or more than 10000” is large in number of vehicles on the market and therefore has a large influence if an anomaly occurs, so that the base risk value of an anomaly that occurs in mobile object 100 of a model described as “the number of vehicles on the market is equal to or more than 10000” is substantially corrected.

Furthermore, as illustrated in Part (a) of FIG. 7, priority determination system 10 stores a rule that the base risk value of an anomaly that occurs in mobile object 100 of a model described as “an anticipated damage is less than the profit in the first half” is corrected by a factor of 1.0 and a rule that the base risk value of an anomaly that occurs in mobile object 100 of a model described as “an anticipated damage is equal to or more than the profit in the first half” is corrected by a factor of 2.0. Mobile object 100 of a model described as “an anticipated damage is less than the profit in the first half” is small in an anticipated damage, so that the base risk value of an anomaly that occurs in mobile object 100 of a model described as “an anticipated damage is less than the profit in the first half” is not substantially corrected. On the other hand, mobile object 100 of a model described as “an anticipated is equal to or more than the profit in the first half” is large in an anticipated damage, so that the base risk value of an anomaly that occurs in mobile object 100 of a model described as “an anticipated damage is equal to or more than the profit in the first half” is substantially corrected. Note that the correction value (scale factor) may be stored in association with the model or may be stored in association with the number of vehicles on the market, an anticipated damage or the like. When the correction value is stored in association with the number of vehicles on the market, an anticipated damage or the like, priority determination system 10 may store the models and the number of vehicles on the market, an anticipated damage or the like for each model as intermediate values or may obtain these items of information by inquiring of an external system.

Furthermore, for example, as illustrated in Part (a) of FIG. 7, priority determination system 10 stores a rule that the base risk value of an anomaly that occurs in mobile object 100 that is a “private vehicle” is corrected by a factor of 1.0, a rule that the base risk value of an anomaly that occurs in mobile object 100 that is a “business vehicle” is corrected by a factor of 1.2, and the base risk value of an anomaly that occurs in mobile object 100 that is an “emergency vehicle” is corrected by a factor of 2.0. Mobile object 100 that is a “private vehicle” is less frequently used and therefore is less likely to cause a problem even if an anomaly occurs, so that the base risk value of an anomaly that occurs in mobile object 100 that is a “private vehicle” is not substantially corrected. Mobile object 100 that is a “business vehicle” is frequently used and therefore is likely to cause a problem when an anomaly occurs, so that the base risk value of an anomaly that occurs in mobile object 100 that is a “business vehicle” is more substantially corrected than a “private vehicle”. Mobile object 100 that is an “emergency vehicle” has a great severity, so that the base risk value of an anomaly that occurs in mobile object 100 that is an “emergency vehicle” is substantially corrected.

Furthermore, as illustrated in Part (b) of FIG. 7, priority determination system 10 stores a rule that the base risk value of an anomaly that occurs in mobile object 100 located in a “rural area” is corrected by a factor of 1.0 and a rule that the base risk value of an anomaly that occurs in mobile object 100 located in an “urban area” is corrected by a factor of 2.0. There are less people and less traffic in rural areas, so that the base risk value of an anomaly that occurs in mobile object 100 located in a “rural area” is not substantially corrected. There are more people and more traffic in urban areas, so that the base risk value of an anomaly that occurs in mobile object 100 located in an “urban area” is substantially corrected.

Furthermore, as illustrated in Part (b) of FIG. 7, priority determination system 10 stores a rule that the base risk value of an anomaly that occurs in mobile object 100 that is “stopped” is corrected by a factor of 1.0 and a rule that the base risk value of an anomaly that occurs in mobile object 100 that is “traveling” is corrected by a factor of 2.0. Mobile object 100 that is “being stopped” is stopped, and therefore, a dangerous situation is less likely to occur even if an anomaly occurs, so that the base risk value of an anomaly that occurs in mobile object 100 that is “being stopped” is not substantially corrected. Mobile object 100 that is “traveling” is traveling, and therefore, a dangerous situation is likely to occur when an anomaly occurs, so that the base risk value of an anomaly that occurs in mobile object 100 that is “traveling” is substantially corrected.

Furthermore, as illustrated in Part (b) of FIG. 7, priority determination system 10 stores a rule that the base risk value of an anomaly that occurs in mobile object 100 that is in a “conventional driving” state is corrected by a factor of 1.0, a rule that the base risk value of an anomaly that occurs in mobile object 100 that is in a “semi-autonomous driving” state is corrected by a factor of 1.2, and a rule that the base risk value of an anomaly that occurs in mobile object 100 that is in a “fully autonomous driving” state is corrected by a factor of 1.5. Mobile object 100 that is in the “conventional driving” state is conventionally driven, and therefore, a dangerous situation is less likely to occur even if an anomaly occurs, so that the base risk value of an anomaly that occurs in mobile object 100 that is in the “conventional driving” state is not substantially corrected. Mobile object 100 that is in the “semi-autonomous driving” state or the “fully autonomous driving” state is autonomously driven, and therefore, a dangerous situation is likely to occur when an anomaly occurs, so that the base risk value of an anomaly that occurs in mobile object 100 that is in the “semi-autonomous driving” state or the “fully autonomous driving” state is substantially corrected.

Furthermore, as illustrated in Part (b) of FIG. 7, priority determination system 10 stores a rule that the base risk value of an anomaly that occurs in mobile object 100 that is “not being charged/discharged” is corrected by a factor of 1.0, a rule that the base risk value of an anomaly that occurs in mobile object 100 that is “being discharged” is corrected by a factor of 1.2, and a rule that the base risk value of an anomaly that occurs in mobile object 100 that is “being V2X-discharged” or “being charged” is corrected by a factor of 1.5. Mobile object 100 that is “not being charged/discharged” is not charged or discharged, and therefore, a dangerous situation is less likely to occur even if an anomaly occurs, so that the base risk value of an anomaly that occurs in mobile object 100 that is “not being charged/discharged” is not substantially corrected. Mobile object 100 that is “being discharged”, “being V2X-discharged”, or “being charged” is being charged or discharged, and therefore, a dangerous situation is likely to occur when an anomaly occurs, so that the base risk value of an anomaly that occurs in mobile object 100 that is “being discharged”, “being V2X-discharged”, or “being charged” is substantially corrected.

For example, as illustrated in FIG. 5, when mobile object 100 in which an anomaly has occurred is traveling (the scale factor is 2.0), is located in an urban area (the scale factor is 2.0), is in the semi-autonomous driving state (the scale factor is 1.2), is not charged/discharged (the scale factor is 1.0), and is of model A (specifically, as illustrated in Part (a) of FIG. 6, the number of vehicles on the market is 5000 (the scale factor is 1.2), an anticipated is less than the profit in the first half (the scale factor is 1.0), and mobile object 100 is a business vehicle (the scale factor is 1.2)), the risk value can be calculated as follows.

$$Risk value = base risk value \times 2. \times 2.0 \times 1.2 \times 1.0 \times 1.2 \times 1. \times 1.2$$

As described above, for each of the plurality of items of anomaly data, risk value calculator 14 calculates a risk value for an anomaly by correcting the base risk value based on the circumstance data about corresponding mobile object 100 (mobile object 100 in which the anomaly has occurred).

Based on the risk value for each of the plurality of items of anomaly data calculated by risk value calculator 14, priority determiner 15 then determines the priority of each task to address the anomaly data (step S14).

For example, when the anomaly that has occurred in mobile object 100 is an “unauthorized communication via In Vehicle Infotainment (IVI)”, “user notification” for notifying the user of mobile object 100 of the occurrence of the anomaly, “disconnection” for disconnecting the IVI and the on-board network, “specific analysis” for specifically analyzing the anomaly, and “persistent patch distribution” for distribution a program or the like to take a measure against the anomaly are defined in advance as tasks to address the anomaly. In other words, priority determination system 10 stores an association between an anomaly and one or more tasks to address the anomaly. Furthermore, each task is associated with the share ratio of the risk value and the estimated response time.

When the percentage of decrease of the risk by performing the “user notification” is 0.10 (10%), and the estimated response time required to complete the “user notification” is 1 second, by performing the “user notification” in 1 second, the risk value of the “unauthorized communication via IVI” can be decreased by 10%.

When the percentage of decrease of the risk by performing the “disconnection” is 0.40 (40%), and the estimated response time required to complete the “disconnection” is 10 seconds, by performing the “disconnection” in 10 seconds, the risk value of the “unauthorized communication via IVI” can be decreased by 40%.

When the percentage of decrease of the risk by performing the “specific analysis” is 0.10 (10%), and the estimated response time required to complete the “specific analysis” is 3600 seconds, by performing the “specific analysis” in 3600 seconds, the risk value of the “unauthorized communication via IVI” can be decreased by 10%.

When the percentage of decrease of the risk by performing the “persistent patch distribution” is 0.40 (40%), and the estimated response time required to complete the “persistent patch distribution” is 60 seconds, by performing the “persistent patch distribution” in 60 seconds, the risk value of the “unauthorized communication via IVI” can be decreased by 40%.

For example, the priority of each task is determined in such a manner that the higher the percentage of decrease of the risk by execution of the task, the higher the priority of the task is, and the shorter the time required to execute the task, the higher the priority of the task is. That is, priority determiner 15 assigns a higher priority to a task that can more substantially decrease the risk in a shorter time. For example, priority determination system 10 stores a rule that can be expressed by a formula for priority, such as the equations 1 and 2 below, and priority determiner 15 determines the priority of each task by substituting the share ratio of the risk value and the estimated response time into the formula. Note that in the equations 1 and 2 below, rvdec denotes the amount of decrease of the risk value, rv denotes the risk value, rratio denotes the share ratio of the risk value, p denotes the severity of the task (p can be said as the severity of the task, because it is desirable to preferentially execute a task of higher importance), a denotes the tuning weight, and test denotes the estimated response time.

$$[ Math . 1 ]$$

$${rv}_{dec} = rv \cdot {r}_{ratio} \qquad Equation 1$$

$$[ Math . 2 ]$$

$$p = α \frac{{rv}_{dec}}{{t}_{est}} \qquad Equation 2$$

Note that in the equations 1 and 2 above, when the share ratio of the risk value or the estimated response time are extremely low or extremely high, the priority of the task greatly varies. In view of this, the equation 3 below can also be used to determine the priority. Note that α is equal to or greater than 1 in the equation 3 below.

$$[ Math . 3 ]$$

$$p = log ( α + {rv}_{dec} / {t}_{est} ) \qquad Equation 3$$

However, among the tasks to address the “unauthorized communication via IVI”, for example, the “persistent patch distribution” is a task that can be executed only after the “specific analysis” is completed. Therefore, priority determination system 10 stores a rule that prevents the priority of the “persistent patch distribution” from being higher than the priority of the “specific analysis”. For example, the priority of a particular task can be increased or decreased by adjusting the tuning weight for the task.

For example, priority determination system 10 stores associations between other various abnormalities than the “unauthorized communication via IVI” and one or more tasks, and priority determiner 15 can determine the priority of each task by referring to the associations for various abnormalities. Note that the “unauthorized communication via IVI” is associated with a plurality of tasks, there may be an anomaly that is associated with only one task.

As described above, priority determiner 15 determines the priority of each risk based on the risk value calculated by risk value calculator 14. Specifically, priority determiner 15 assigns a higher priority to a task that decreases the risk with a higher percentage of decrease when the task is executed (in other words, assigns a lower priority to a task that decreases the risk with a lower percentage of decrease when the task is executed) and assigns a higher priority to a task that requires a shorter time to execute (in other words, assigns a lower priority to a task that requires a longer time to execute).

Outputter 17 then provides an output based on the result of the determination by priority determiner 15 (step S15). For example, outputter 17 outputs, to display 201, an alert that prompts to execute tasks in order of priority as the output based on the result of the determination, and display 201 displays the alert. Note that outputter 17 may output the alert to a speaker or the like, and the speaker or the like may output the alert as audio. In this way, the analyst can perform tasks in order of priority. Note that the determination of priorities and the output based on the result of the determination may be performed when a new anomaly is detected, may be performed regularly, may be performed when the priorities are redetermined, or may be performed in combination of these timings.

For each of the plurality of items of anomaly data, circumstance change notification manager 16 then determines whether or not the anomaly data is circumstance change notification target data that requires corresponding mobile object 100 to send circumstance data after change when circumstances have changed (step S16). For example, circumstance change notification manager 16 determines a particular type of anomaly data among the plurality of items of anomaly data to be circumstance change notification target data.

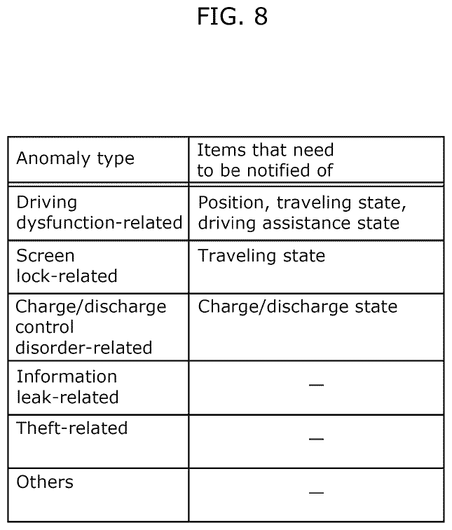

FIG. 8 is a diagram illustrating an example of the circumstance change notification target data. As circumstance change notification target data, FIG. 8 illustrates driving dysfunction-related anomaly data, screen lock-related anomaly data, and charge/discharge control disorder-related anomaly data. Note that FIG. 8 also illustrates information leak-related anomaly data and theft-related anomaly data as anomaly data that is not circumstance change notification target data. FIG. 8 also illustrates circumstance items (referred to also as circumstance change notification target items) that needs to be notified of when the circumstances have changed, for each item of circumstance change notification target data.

For example, among the plurality of items of anomaly data, circumstance change notification manager 16 determines driving dysfunction-related anomaly data, screen lock-related anomaly data, and charge/discharge control disorder-related anomaly data to be the particular type of anomaly data, that is, circumstance change notification target data. The particular type of anomaly data is data that can change in risk of the anomaly when a circumstance of mobile object 100 has changed or, in other words, data that can change in calculated risk value and thus in determined priority.

For example, when a driving dysfunction-related anomaly that affects the driving capability to compromise driving safety has occurred in mobile object 100, if the position, the traveling state, or the driving assistance state of mobile object 100 changes, the risk of the anomaly can change. For example, if the position of mobile object 100 at the time of occurrence of the anomaly is the “rural area”, the risk of the anomaly is low. However, after that, if the position changes to the “urban area”, the risk of the anomaly increases. Therefore, circumstance change notification manager 16 determines the anomaly data to be circumstance change notification target data that requires corresponding mobile object 100 (specifically, mobile object 100 that has transmitted the anomaly data) to send circumstance data after change when circumstances have changed.

Furthermore, for example, when a screen lock-related anomaly has occurred in mobile object 100, such as when the screen of on-board information equipment, such as a car navigation system, has been locked and the equipment cannot be operated, if the traveling state of mobile object 100 changes, the risk of the anomaly can change. For example, if mobile object 100 is “being stopped” at the time of occurrence of the anomaly, the risk of the anomaly is low. However, after that, if the traveling state of mobile object 100 changes to “traveling”, the risk of the anomaly increases. Therefore, circumstance change notification manager 16 determines the screen lock-related anomaly data to be circumstance change notification target data that requires corresponding mobile object 100 to send circumstance data after change when circumstances have changed.

Furthermore, for example, when a charge/discharge control disorder-related anomaly, which is an anomaly of the charge/discharge control of a battery (such as eddy current), has occurred in mobile object 100, if the charge/discharge state of mobile object 100 changes, the risk of the anomaly can change. For example, if mobile object 100 is “not being discharge” at the time of occurrence of the anomaly, the risk of the anomaly is low. However, after that, if the charge/discharge state of mobile object 100 changes to the “being charged”, the risk of the anomaly increases. Therefore, circumstance change notification manager 16 determines the charge/discharge control disorder-related anomaly data to be circumstance change notification target data that requires corresponding mobile object 100 to send circumstance data after change when circumstances have changed.

Note that when a theft-related anomaly, such as forced unlocking, has occurred in mobile object 100, for example, the risk of the anomaly is less likely to change even if a circumstance of mobile object 100 changes. Therefore, circumstance change notification manager 16 does not determine the theft-related anomaly data to be circumstance change notification target data that requires corresponding mobile object 100 to send circumstance data after change when circumstances have changed.

When circumstance change notification manager 16 determines that each of the plurality of items of anomaly data is not circumstance change notification target data (No in step S16), the process ends.

When circumstance change notification manager 16 determines that any of the plurality of items of anomaly data is circumstance change notification target data (Yes in step S16), circumstance change notification manager 16 requests mobile object 100 corresponding to the anomaly data determined to be circumstance change notification target data to send circumstance data after change when circumstances have changed or, in other words, transmits a circumstance change notification start request to mobile object 100 corresponding to the anomaly data determined to be circumstance change notification target data (step S17). The circumstance change notification start request is information that indicates to send circumstance data after change when circumstances have changed. For example, circumstance change notification manager 16 determines a circumstance item relating to a particular type of anomaly data, and requests mobile object 100 corresponding to anomaly data determined to be circumstance change notification target data to send circumstance data after change when a circumstance corresponding to the item has changed.

For example, by referring to associations between types of abnormalities and circumstance items (circumstance change notification target items) such as those illustrated in FIG. 8, circumstance change notification manager 16 determines circumstance items “position”, “traveling state”, and “driving assistance state” relating to driving dysfunction-related anomaly data to be particular types of anomaly data, and requests mobile object 100 corresponding to the anomaly data determined to be circumstance change notification target data to send circumstance data after change when a circumstance corresponding to any of the items has changed. Thus, mobile object 100 having received the request monitors the “position”, the “traveling state”, and the “driving assistance state” of mobile object 100, and when any of the “position”, the “traveling state”, and the “driving assistance state” changes, mobile object 100 can notify priority determination system 10 of the “position”, the “traveling state”, or the “driving assistance state” after change.

Furthermore, for example, by referring to associations between types of abnormalities and circumstance items such as those illustrated in FIG. 8, circumstance change notification manager 16 determines a circumstance item “traveling state” relating to screen lock-related anomaly data to be a particular type of anomaly data, and requests mobile object 100 corresponding to the anomaly data to send circumstance data after change when a circumstance corresponding to “traveling state” has changed. Thus, mobile object 100 having received the request monitors the “traveling state” of mobile object 100, and when the “traveling state” changes, mobile object 100 can notify priority determination system 10 of the “traveling state” after change.

Furthermore, for example, by referring to associations between types of abnormalities and circumstance items such as those illustrated in FIG. 8, circumstance change notification manager 16 determines a circumstance item “charge/discharge state” relating to charge/discharge control disorder-related anomaly data to be a particular type of anomaly data, and requests mobile object 100 corresponding to the anomaly data to send circumstance data after change when a circumstance corresponding to “charge/discharge state” has changed. Thus, mobile object 100 having received the request monitors the “charge/discharge state” of mobile object 100, and when the “charge/discharge state” changes, mobile object 100 can notify priority determination system 10 of the “charge/discharge state” after change.

Priority determination system 10 then transitions to a circumstance change notification waiting state to wait for a circumstance change notification from mobile object 100 to which the circumstance change notification start request has been transmitted (step S18).

Note that the processing in step S11 and the processing in step S12 may be performed in reverse order or in parallel. Furthermore, the procedure from step S16 to step S18 have only to be performed after step S11 and step S12 are performed and may be performed before step S13, step S14, or step S15.

Furthermore, the particular types of abnormalities, the circumstance change notification target items, and the combinations thereof are not limited to those illustrated in FIG. 8. For example, the particular types of abnormalities, the circumstance change notification target items, and the combinations thereof can be increased or modified as required.

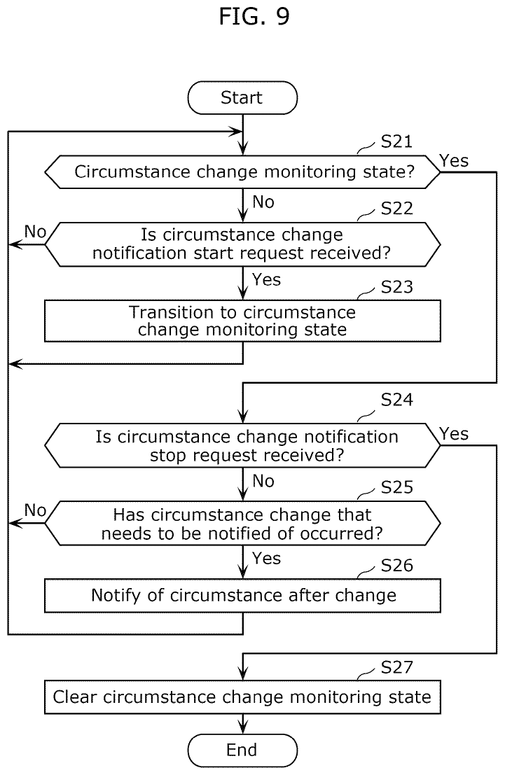

FIG. 9 is a flowchart illustrating an example of an operation concerning the circumstance change notification by mobile object 100 according to the embodiment.

Circumstance notifier 102 determines whether the current state is a circumstance change monitoring state or not (step S21), and when the current state is not the circumstance change monitoring state (No in step S21), circumstance notifier 102 determines whether a circumstance change notification start request has been received or not (step S22). When a circumstance change notification start request has been received (Yes in step S22), circumstance notifier 102 transitions to the circumstance change monitoring state (step S23). When no circumstance change notification start request has been received (No in step S22), circumstance notifier 102 performs the procedure from step S21 again.

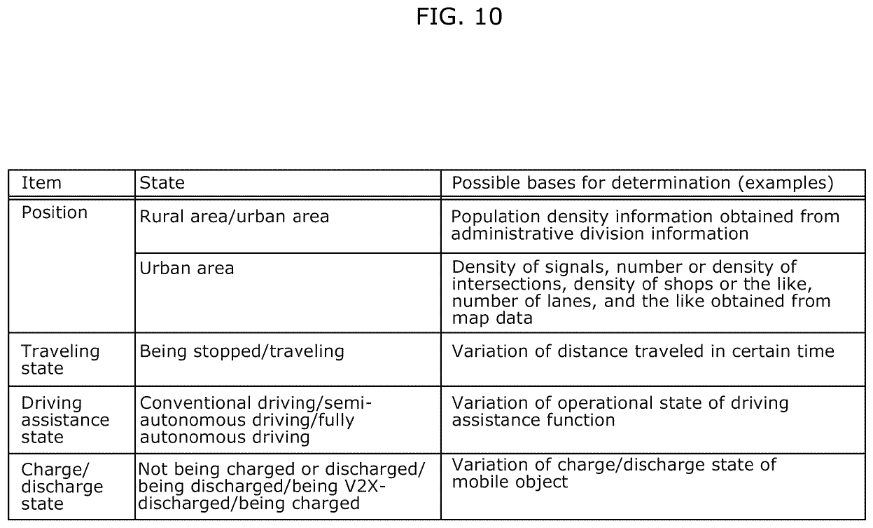

When the current state is a circumstance change monitoring state (Yes in step S21), circumstance notifier 102 determines whether a circumstance change notification stop request has been received or not (step S24). When no circumstance change notification stop request has been received (No in step S24), circumstance notifier 102 determines whether a circumstance change that needs to be notified of has occurred or not (step S25). A method of determining a circumstance change by mobile object 100 will be described hereinafter with reference to FIG. 10.

FIG. 10 is a diagram for describing a method of determining a circumstance change for various circumstance items.

For example, whether or not the position has changed to a rural area or an urban area can be determined based on population density information obtained from administrative division information. Furthermore, for example, whether or not the position has changed to an urban area can be determined based on the density of signals, the number or density of intersections, the density of shops or the like, the number of lanes, or the like obtained from map data.

For example, whether or not the traveling state has changed to “being stopped” or “traveling” can be determined based on the variation of the distance traveled in a certain time.

For example, whether or not the driving assistance state has changed to the conventional driving, the semi-autonomous driving, or the fully autonomous driving can be determined based on the variation of the operational state of the driving assistance function.

For example, whether or not the charge/discharge state has changed to “not being charged/discharged”, “being discharged”, “being V2X-discharged”, or “being charged” can be determined based on the variation of the charge/discharge state of the mobile object.

When no circumstance change that needs to be notified of has occurred (No in step S25), circumstance notifier 102 performs the procedure from step S21 again. When a circumstance change that needs to be notified of has occurred (Yes in step S25), circumstance notifier 102 notifies priority determination system 10 of the circumstance after change (step S26), and performs the procedure from step S21 again.

When a circumstance change notification stop request has been received (Yes in step S24), circumstance notifier 102 clears the circumstance change monitoring state (step S27).

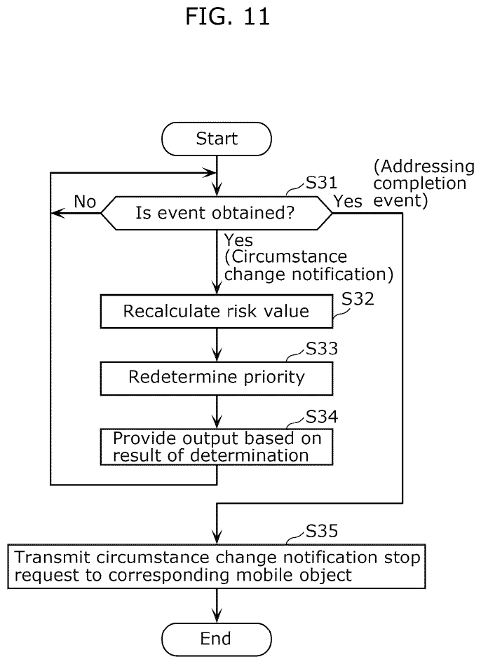

FIG. 11 is a flowchart illustrating an example of an operation of priority determination system 10 in the circumstance change notification waiting state according to the embodiment.

Incident manager 13 determines whether or not an event has been obtained (step S31). For example, the event is an addressing completion event from the analyst or an event of circumstance change notification from mobile object 100 (specifically, an event indicating that circumstance data after change has been obtained). When no event has been obtained (No in step S31), incident manager 13 performs the procedure from step S31 again.

When incident manager 13 has obtained an event of circumstance change notification (Yes in step S31 (circumstance change notification)), that is, when incident manager 13 has obtained circumstance data after change, risk value calculator 14 recalculate the risk value of anomaly data about corresponding mobile object 100 based on the circumstance data after change (step S32). For example, when the risk value of driving dysfunction-related anomaly data about mobile object 100 whose traveling state is “being stopped” has been calculated to be 400 based on the scale factor of 1.0 for “being stopped”, if circumstance data indicating that the traveling state of mobile object 100 has changed to “traveling” is obtained, risk value calculator 14 recalculates the risk value of the anomaly data about mobile object 100 to be 800 based on the scale factor of 2.0 for “traveling”.

Based on the recalculated risk value, priority determiner 15 then redetermines the priorities of tasks to address the anomaly indicated by the anomaly data about corresponding mobile object 100 (step S33). For example, the priority of a task to address an anomaly indicated by driving dysfunction-related anomaly data about mobile object 100 that has transmitted circumstance data indicating that the traveling state has changed from “being stopped” to “traveling” is raised.

Outputter 17 then provides an output based on the result of the determination by priority determiner 15 (step S34). For example, outputter 17 can output a different determination result than the previously output determination result so that a task whose priority has been raised according to the circumstances of mobile object 100 can be executed.

On the other hand, when incident manager 13 has obtained an addressing completion event (Yes in step S31 (addressing completion event)), specifically, when the anomaly indicated by the particular type of anomaly data about mobile object 100 that has transmitted the circumstance change notification start request has been addressed, circumstance change notification manager 16 makes mobile object 100 corresponding to the anomaly data determined to be circumstance change notification target data stop sending circumstance data after change or, in other words, transmits a circumstance change notification stop request (step S35). The circumstance change notification stop request is information that indicates to stop sending circumstance data after change when circumstances have changed.

As described above, for circumstance change notification target data among a plurality of items of anomaly data, corresponding mobile object 100 sends circumstance data after change when circumstances have changed. Therefore, when a circumstance of mobile object 100 changes after circumstance data about mobile object 100 is once obtained, the risk value is recalculated according to the changed circumstance, and the priorities of tasks are redetermined. Therefore, the priorities of tasks can be appropriately determined according to the change in circumstances of mobile object 100.

### OTHER EMBODIMENTS

An embodiment has been described above as an example of the technique according to the present disclosure. However, the technique according to the present disclosure is not limited to the embodiment, and modifications, replacements, additions, omissions, and the like can be made to the embodiment as required. For example, the variations described below are included in embodiments of the present disclosure.

For example, although in the embodiment described above, an example has been described in which the components of priority determination system 10 are disposed in a server, the present disclosure is not limited to this. For example, anomaly obtainer 11, circumstance obtainer 12, incident manager 13, risk value calculator 14, and circumstance change notification manager 16 may be disposed in mobile object 100. In that case, mobile object 100 in which these components are disposed may obtain circumstance data from the server that collects circumstance data from the plurality of mobile objects 100, or the plurality of mobile objects 100 may share circumstance data about the plurality of mobile objects 100. Furthermore, priority determiner 15 may be disposed in mobile object 100. For example, the determined priorities of tasks (importances of tasks) may be added to information indicating an alert, and mobile object 100 in which priority determiner 15 is disposed may send the alert to the server or the like. Furthermore, mobile object 100 in which priority determiner 15 is disposed may inquire of the server that stores definitions of tasks about a task to address an anomaly, the share ratio of a risk value, an estimated response time or the like, or the plurality of mobile objects 100 may share these items of information.

Furthermore, for example, although in the embodiment described above, an example has been described in which the priority of each task is determined based on the risk value of each of a plurality of items of anomaly data and both of the percentage of decrease of the risk by execution of the task and the time required to execute the task as shown by the equations 1 to 3 described above, the present disclosure is not limited to this. For example, the priority of each task may be determined based on the risk value of each of a plurality of items of anomaly data and any one of the percentage of decrease of the risk by execution of the task and the time required to execute the task.

Furthermore, for example, among a plurality of items of anomaly data, priority determination system 10 may process items of anomaly data that have occurred at nearby places as one item of anomaly data.

Furthermore, for example, although in the embodiment described above, an example has been described in which the terminal such as SOC is capable of wire or radio communication with priority determination system 10, and priority determination system 10 (outputter 17) provides an output based on the result of determination of priorities to display 201 or the like of the terminal, the present disclosure is not limited to this. For example, the determined priority of each task may be provided to an automation tool such as SOAR, and the tasks may be automatically processed based on the determined priorities.

Furthermore, for example, the functions of priority determination system 10 may be implemented by an automation tool such as SOAR, the output based on the determination of priorities may be provided by the automation tool.

Furthermore, for example, although in the embodiment described above, an example has been described in which circumstance change notification manager 16 determines a circumstance item corresponding to a particular type of anomaly data and requests mobile object 100 corresponding to the anomaly data determined to be circumstance change notification target data to send circumstance data after change when a circumstance corresponding to the item has changed, the present disclosure is not limited to this. For example, circumstance change notification manager 16 need not determine a circumstance item corresponding to a particular type of anomaly data, and may request mobile object 100 corresponding to the anomaly data determined to be circumstance change notification target data to send circumstance data after change when a circumstance corresponding to any item has changed.

Furthermore, for example, although in the embodiment described above, an example has been described in which when an anomaly indicated by a particular type of anomaly data is addressed, circumstance change notification manager 16 makes mobile object 100 corresponding to the anomaly data determined to be circumstance change notification target data stop sending circumstance data after change, the present disclosure is not limited to this. For example, even if an anomaly indicated by a particular type of anomaly data is addressed, circumstance change notification manager 16 need not make mobile object 100 corresponding to the anomaly data determined to be circumstance change notification target data stop sending circumstance data after change. For example, mobile object 100 may automatically clear the circumstance change monitoring state when a predetermined time has elapsed, for example.

Furthermore, for example, mobile object 100 is not limited to a vehicle and may be a train, an aircraft (such as an unmanned aircraft), or a ship, for example.

Note that the present disclosure can be implemented not only as priority determination system 10 but also as a priority determination method including steps (processing) performed by the components of priority determination system 10.

As illustrated in FIGS. 4 and 11, the priority determination method includes: processing of obtaining a plurality of items of anomaly data each of which indicates an anomaly of a corresponding one of a plurality of mobile objects (step S11); processing of obtaining a plurality of items of circumstance data each of which indicates a circumstance of a corresponding one of the plurality of mobile objects (step S12); processing of calculating, for each of the plurality of items of anomaly data, a risk value that indicates a risk of an anomaly based on circumstance data about a corresponding mobile object (step S13); processing of determining a priority of each task to address an anomaly indicated by each of the plurality of items of anomaly data based on the risk value of the anomaly data (step S14); processing of providing an output based on a result of the determination (step S15); processing of determining whether or not each of the plurality of items of anomaly data is circumstance change notification target data that requests a corresponding mobile object to send circumstance data after change when circumstances have changed (step S16); processing of requesting a mobile object corresponding to anomaly data determined to be the circumstance change notification target data to send circumstance data after change when circumstances have changed (step S17); when circumstance data after change is obtained, processing of recalculating the risk value of the anomaly data about the corresponding mobile object based on the circumstance data after change (step S32); and processing of redetermining the priority of a task to address an anomaly indicated by the anomaly data about the corresponding mobile object based on the recalculated risk value (step S33).

For example, steps in the priority determination method may be performed by a computer (computer system). The present disclosure can be realized as a program for causing the computer to perform the steps included in the priority determination method.

Moreover, the present disclosure can be realized as a non-transitory computer-readable recording medium such as a CD-ROM on which the program is recorded.

When the present disclosure is achieved by a program (software), each of the steps is performed by the program performed by utilizing hardware resources of, for instance, a CPU, memory, and an input/output circuit in the computer. In other words, each step is performed by the CPU obtaining or calculating data from, for instance, the memory or the input/output circuit, or outputting a calculation result to the memory or the input/output circuit.

Each of components included in priority determination system 10 according to the above embodiment may be realized as a dedicated or general circuit.

Each of the components included in priority determination system 10 according to the above embodiment may be realized as a large scale integration (LSI) circuit that is an integrated circuit (IC).

The components need not be implemented as LSIs but may be implemented as dedicated circuits or general-purpose processors. A field programmable gate array (FPGA) that can be programmed or a reconfigurable processor that can reconfigure the connection or configuration of circuit cells in the LSI.

Furthermore, if other technologies that improve upon or are derived from semiconductor technology enable integration technology to replace LSI circuits, then naturally it is also possible to integrate the components included in priority determination system 10 using that technology.

Other embodiments obtained by various modifications to the embodiments which may be conceived by those skilled in the art, and embodiments achieved by combining elements and functions described in each of the embodiments are also included in the scope of the present disclosure so long as they do not depart from the essence of the present disclosure.

### SUPPLEMENTARY NOTES

Based on the embodiments described above, the following techniques are disclosed.

(Technique 1) A priority determination system comprising:
an anomaly obtainer that obtains a plurality of items of anomaly data each of which indicates an anomaly of a corresponding one of a plurality of mobile objects;
a circumstance obtainer that obtains a plurality of items of circumstance data each of which indicates circumstances of a corresponding one of the plurality of mobile objects;
a risk value calculator that calculates, for each of the plurality of items of anomaly data, a risk value that indicates a risk of an anomaly based on circumstance data about a corresponding mobile object;
a priority determiner that determines a priority of each task to address an anomaly indicated by each of the plurality of items of anomaly data, based on the risk value of the anomaly data;
an outputter that provides an output based on a result of the determination; and
a circumstance change notification manager that determines whether or not each of the plurality of items of anomaly data is circumstance change notification target data that requests a corresponding mobile object to send circumstance data after change when circumstances have changed,
wherein the circumstance change notification manager requests a mobile object corresponding to anomaly data determined to be the circumstance change notification target data to send circumstance data after change when circumstances have changed,
when circumstance data after change is obtained, the risk value calculator recalculates the risk value of the anomaly data about the corresponding mobile object based on the circumstance data after change, and
the priority determiner redetermines the priority of a task to address an anomaly indicated by the anomaly data about the corresponding mobile object based on the recalculated risk value.

According to this, for circumstance change notification target data among a plurality of items of anomaly data, the corresponding mobile object sends circumstance data after change when circumstances have changed. Therefore, when a circumstance of the mobile object changes after circumstance data about the mobile object is once obtained, the risk value is recalculated according to the changed circumstance, and the priorities of tasks are redetermined. Therefore, the priorities of tasks can be appropriately determined according to the change in circumstances of the mobile object.

(Technique 2) The priority determination system according to Technique 1, wherein
the circumstance change notification manager determines a particular type of anomaly data among the plurality of items of anomaly data to be the circumstance change notification target data. For example, depending on the type of the anomaly, the risk value may not change even if a circumstance of the mobile object changes. Thus, the system can be efficiently operated by making only the mobile object in which an anomaly that requires monitoring for a change of a circumstance send circumstance data after change when circumstances have changed.

(Technique 3) The priority determination system according to Technique 2, wherein
the circumstance change notification manager determines a circumstance item corresponding to the particular type of the anomaly data, and requests a mobile object corresponding to the anomaly data determined to be the circumstance change notification target data to send circumstance data after change when circumstances relating to the item have changed.

For example, depending on the circumstance item of the mobile object, the risk value may not change even if the circumstance item changes. Thus, the system can be efficiently operated by making the mobile object monitor for only a change of a circumstance item that needs to be monitored for.

(Technique 4) The priority determination system according to Technique 2 or 3, wherein
when an anomaly indicated by the particular type of the anomaly data is addressed, the circumstance change notification manager causes the mobile object corresponding to the anomaly data determined to be the circumstance change notification target data to stop sending circumstance data after change.

According to this, when the anomaly is addressed, notification of the circumstance after change from the mobile object in which the anomaly occurred is no longer needed and therefore can be stopped.

(Technique 5) The priority determination system according to any one of Techniques 1 to 4, wherein
each of the plurality of items of circumstance data includes at least one item of information among type information indicating a type of the mobile object, position information indicating a position of the mobile object, traffic information about a site corresponding to the position information, traveling state information indicating a traveling state of the mobile object, driving assistance state information indicating a driving assistance state of the mobile object, and charge and discharge state information indicating a charge and discharge state of the mobile object.

According to this, at least one item of information among the type information, the position information, the traffic information, the traveling state information, the driving assistance state information, and the charge/discharge state information, which can affect the risk of abnormalities, can be reflected in the risk value.

(Technique 6) The priority determination system according to any one of Techniques 1 to 5, wherein
the risk value is a value obtained by correcting a base risk value determined according to a type of an anomaly with use of circumstance data about a corresponding mobile object.

According to this, the risk value can be easily calculated by correcting the base risk value, which can be easily determined according to the type of the anomaly, with circumstance data.

(Technique 7) The priority determination system according to any one of Techniques 1 to 6, wherein
the priority of each task is determined based on the risk value of each of the plurality of items of anomaly data and a predetermined index value of the task.

According to this, the priority of each task can be easily determined based on the risk value of each of the plurality of items of anomaly data and the predetermined index value of the task.

(Technique 8) The priority determination system according to Technique 7, wherein
the predetermined index value of each task is at least one of a percentage of decrease of the risk by execution of the task and a time required to execute the task.

According to this, a higher priority can be assigned to a task that can more substantially decrease the risk if the task is executed, and a higher priority can be assigned to a task that requires a shorter time to execute.

(Technique 9) The priority determination system according to any one of Techniques 1 to 8, wherein
the priority determiner performs the determination regularly, each time a task is executed, each time an anomaly is detected, or each time the risk value is calculated.

According to this, the determination of priorities can be automatically performed at these timings.

(Technique 10) A priority determination method comprising: obtaining a plurality of items of anomaly data each of which indicates an anomaly of a corresponding one of a plurality of mobile objects;
obtaining a plurality of items of circumstance data each of which indicates circumstances of a corresponding one of the plurality of mobile objects;
calculating, for each of the plurality of items of anomaly data, a risk value that indicates a risk of an anomaly based on circumstance data about a corresponding mobile object;
determining a priority of each task to address an anomaly indicated by each of the plurality of items of anomaly data, based on the risk value of the anomaly data;
providing an output based on a result of the determination; and determining whether or not each of the plurality of items of anomaly data is circumstance change notification target data that requests a corresponding mobile object to send circumstance data after change when circumstances have changed;
requesting a mobile object corresponding to anomaly data determined to be the circumstance change notification target data to send circumstance data after change when circumstances have changed;
when circumstance data after change is obtained, recalculating the risk value of the anomaly data about the corresponding mobile object based on the circumstance data after change; and
redetermining the priority of a task to address an anomaly indicated by the anomaly data about the corresponding mobile object based on the recalculated risk value.

According to this, a priority determination method can be provided which can appropriately determine the priorities of tasks according to a change in circumstances of the mobile object.

(Technique 11) A program that causes a computer to perform the priority determination method according to Technique 10.

According to this, a program can be provided which can appropriately determine the priorities of tasks according to a change in circumstances of the mobile object.

While various embodiments have been described herein above, it is to be appreciated that various changes in form and detail may be made without departing from the spirit and scope of the present disclosure as presently or hereafter claimed.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2022-172040 filed on Oct. 27, 2022, and PCT International Application No. PCT/JP2023/022939 filed on Jun. 21, 2023.

### INDUSTRIAL APPLICABILITY

The present disclosure can be applied to systems that monitor, for example, vehicles.

1. A priority determination system comprising:
an anomaly obtainer that obtains a plurality of items of anomaly data each of which indicates an anomaly of a corresponding one of a plurality of mobile objects;
a circumstance obtainer that obtains a plurality of items of circumstance data each of which indicates circumstances of a corresponding one of the plurality of mobile objects;
a risk value calculator that calculates, for each of the plurality of items of anomaly data, a risk value that indicates a risk of an anomaly based on circumstance data about a corresponding mobile object;
a priority determiner that determines a priority of each task to address an anomaly indicated by each of the plurality of items of anomaly data, based on the risk value of the anomaly data;
an outputter that provides an output based on a result of the determination; and
a circumstance change notification manager that determines whether or not each of the plurality of items of anomaly data is circumstance change notification target data that requests a corresponding mobile object to send circumstance data after change when circumstances have changed,
wherein the circumstance change notification manager requests a mobile object corresponding to anomaly data determined to be the circumstance change notification target data to send circumstance data after change when circumstances have changed,
when circumstance data after change is obtained, the risk value calculator recalculates the risk value of the anomaly data about the corresponding mobile object based on the circumstance data after change, and
the priority determiner redetermines the priority of a task to address an anomaly indicated by the anomaly data about the corresponding mobile object based on the recalculated risk value.

2. The priority determination system according to claim 1, wherein
the circumstance change notification manager determines a particular type of anomaly data among the plurality of items of anomaly data to be the circumstance change notification target data.

3. The priority determination system according to claim 2, wherein
the circumstance change notification manager determines a circumstance item corresponding to the particular type of the anomaly data, and requests a mobile object corresponding to the anomaly data determined to be the circumstance change notification target data to send circumstance data after change when circumstances relating to the item have changed.

4. The priority determination system according to claim 2, wherein
when an anomaly indicated by the particular type of the anomaly data is addressed, the circumstance change notification manager causes the mobile object corresponding to the anomaly data determined to be the circumstance change notification target data to stop sending circumstance data after change.

5. The priority determination system according to claim 1, wherein
each of the plurality of items of circumstance data includes at least one item of information among type information indicating a type of the mobile object, position information indicating a position of the mobile object, traffic information about a site corresponding to the position information, traveling state information indicating a traveling state of the mobile object, driving assistance state information indicating a driving assistance state of the mobile object, and charge and discharge state information indicating a charge and discharge state of the mobile object.

6. The priority determination system according to claim 1, wherein
the risk value is a value obtained by correcting a base risk value determined according to a type of an anomaly with use of circumstance data about a corresponding mobile object.

7. The priority determination system according to claim 1, wherein
the priority of each task is determined based on the risk value of each of the plurality of items of anomaly data and a predetermined index value of the task.

8. The priority determination system according to claim 7, wherein
the predetermined index value of each task is at least one of a percentage of decrease of the risk by execution of the task and a time required to execute the task.

9. The priority determination system according to claim 1, wherein
the priority determiner performs the determination regularly, each time a task is executed, each time an anomaly is detected, or each time the risk value is calculated.

10. A priority determination method comprising:
obtaining a plurality of items of anomaly data each of which indicates an anomaly of a corresponding one of a plurality of mobile objects;
obtaining a plurality of items of circumstance data each of which indicates circumstances of a corresponding one of the plurality of mobile objects;
calculating, for each of the plurality of items of anomaly data, a risk value that indicates a risk of an anomaly based on circumstance data about a corresponding mobile object;
determining a priority of each task to address an anomaly indicated by each of the plurality of items of anomaly data, based on the risk value of the anomaly data;
providing an output based on a result of the determination; and
determining whether or not each of the plurality of items of anomaly data is circumstance change notification target data that requests a corresponding mobile object to send circumstance data after change when circumstances have changed;
requesting a mobile object corresponding to anomaly data determined to be the circumstance change notification target data to send circumstance data after change when circumstances have changed;
when circumstance data after change is obtained, recalculating the risk value of the anomaly data about the corresponding mobile object based on the circumstance data after change; and
redetermining the priority of a task to address an anomaly indicated by the anomaly data about the corresponding mobile object based on the recalculated risk value.
